(19) United States
(12) Patent Application Publication
(10) Pub. No.: US 2015/0127958 A1
(43) Pub. Date: May 7, 2015

(54) INFORMATION PROCESSING APPARATUS, POWER SUPPLY CONTROLLER AND POWER SUPPLY CONTROL METHOD

(71) Applicant: FUJITSU LIMITED, Kawasaki-shi (JP)

(72) Inventors: Yukio YOSHINO, Tokorozawa (JP); Hiroshi SHIMAMORI, Yokosuka (JP)

(73) Assignee: FUJITSU LIMITED, Kawasaki-shi (JP)

(21) Appl. No.: 14/524,233

(22) Filed: Oct. 27, 2014

(30) Foreign Application Priority Data
Nov. 1, 2013 (JP) 2013-228751

(51) Int. Cl. G06F 1/30; G06F 1/26

(52) U.S. Cl. CPC G06F 1/30; G06F 1/263
USPC 713/300

(57) ABSTRACT

An information processing apparatus includes: a processor; a plurality of power controllers, each of the power controllers includes: an electricity supply that supplies electricity supplied from an inserted power supply cable to the processor, and a detector that detects and notifies a half-disconnected state of the power supply cable; and a current controller that in response to a notification from any of the detectors, decreases output current from the electricity supply in a power controller which falls under the half-disconnected state, and increases output current from an electricity supply in another power controller.

### CROSS-REFERENCE TO RELATED APPLICATION

This application is based upon and claims the benefit of priority of the prior Japanese Patent Application No. 2013-228751, filed on Nov. 1, 2013, the entire contents of which are incorporated herein by reference.

### FIELD

The embodiments discussed herein are related to an information processing apparatus, a power supply controller, and a power supply control method.

### BACKGROUND

Information processing apparatuses such as servers include power supply units (PSUs) functioning as power supply control devices. The PSU includes a connector into which a power supply cable extended from an external power supply is to be inserted.

The power supply cable is provided with jacks (female terminals) of L (Live), N (Neutral), and FG (Frame Ground). On the other hand, the PSU connector is provided with pins (male terminals) of L, N, and FG. Then, the power supply cable and the PSU connector are fitted to each other with the jacks and the pins of the same type mated with each other.

The information processing apparatus receives supply of electric power in the PSU via the power supply cable from the external power supply. The PSU performs voltage conversion and the like of the electric power supplied from the external power supply. Thereafter, the information processing apparatus uses the supplied electric power to drive a central processing unit (CPU) and the like.

During operation of such an information processing apparatus, the PSU connector cable plugged into the power supply turns into a half-disconnected state in some cases due to its own weight, an operation failure during maintenance and the like of the apparatus. Here, the half-disconnected state of the power supply cable indicates a state where a power supply failure might occur because the jacks of the power supply cable and the pins of the PSU connector are not sufficiently fitted to each other. In order to reduce occurrence of such a half-disconnected state, some PSUs are provided with a cable clamp for inhibiting an unintended disconnection of the power supply cable. However, the possibility that the half-disconnected state may occur is still high. Therefore, conventionally, an operator visually checks a state of connection.

Meanwhile, there is a related art in which pins of a cable to be connected to a module are configured to have different lengths, and when the cable is half disconnected, a clock signal being supplied to the module is terminated so as to stop the operation of the module.

However, when a half-disconnected state of the power supply cable occurs, since the power supply cable and the PSU connector are not sufficiently fitted to each other, a contact area between the jacks and the pins is reduced resulting in the increasing of a contact resistance. Further, the increase in contact resistance between the power supply cable and the PSU connector generates Joule heat. The power supply cable and the PSU connector might be deteriorated due to a stress applied thereto with this increase in Joule heat.

Moreover, a half-disconnected state may be detected by using the related art in which a removed state is detected with pins having different lengths, but it is difficult to inhibit the power supply cable and the PSU connector from deteriorating.

The following is a reference document:

[Document 1] Japanese Laid-open Patent Publication No. 05-204507.

### SUMMARY

According to an aspect of the invention, an information processing apparatus includes: a processor; a plurality of power controllers, each of the power controllers includes: an electricity supply that supplies electricity supplied from an inserted power supply cable to the processor, and a detector that detects and notifies a half-disconnected state of the power supply cable; and a current controller that in response to a notification from any of the detectors, decreases output current from the electricity supply in a power controller which falls under the half-disconnected state, and increases output current from an electricity supply in another power controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an information processing apparatus according to a first embodiment;

FIG. 2 is a block diagram illustrating a detail of a PSU according to the first embodiment;

FIG. 3A is a side view of a power supply cable according to the first embodiment;

FIG. 3B is a front view of the power supply cable according to the first embodiment;

FIG. 3C is a cross-sectional view of the power supply cable along line A-A′;

FIG. 4A is a front view of a PSU connector according to the first embodiment;

FIG. 4B is a cross-sectional view of the PSU connector along line B-B′;

FIG. 4C is a cross-sectional view of the PSU connector along line C-C′;

FIG. 5A is a circuit diagram of a rectification circuit;

FIG. 5B is a circuit diagram of a power factor correction circuit;

FIG. 5C is a circuit diagram of a DC/DC converter circuit;

FIG. 6 is a diagram for explaining a flow of signals due to a connection between the PSU and the power supply cable according to the first embodiment;

FIG. 7 is a flowchart of power supply control by the information processing apparatus according to the first embodiment;

FIG. 8 is a block diagram of an information processing apparatus according to a second embodiment;

FIG. 9 is a block diagram illustrating a detail of a PSU according to the second embodiment;

FIG. 10A is a side view of a power supply cable according to the second embodiment;

FIG. 10B is a front view of the power supply cable according to the second embodiment;

FIG. 10C is a cross-sectional view of the power supply cable along line D-D′;

FIG. 11A is a front view of a PSU connector according to the second embodiment;

FIG. 11B is a cross-sectional view of the PSU connector along line E-E′;

FIG. 11C is a cross-sectional view of the PSU connector along line F-F′;

FIG. 12 is a table for explaining an operation of a power-cut signal detection circuit when the power supply cable is inserted or removed;

FIG. 13 is a table for explaining an operation of a state determination circuit;

FIG. 14 is a diagram illustrating a flow of signals due to a connection between the PSU and the power supply cable according to the second embodiment;

FIG. 15 is a flowchart of power supply state determination by the information processing apparatus according to the second embodiment;

FIG. 16 is a timing chart of an operation of the PSU when the power supply cable is removed and inserted, and a power failure occurs;

FIG. 17 is a front view of a power supply cable according to a first modification;

FIG. 18A is a front view of a PSU connector according to the first modification;

FIG. 18B is a cross-sectional view of the PSU connector along line G-G′;

FIG. 19 is a view for explaining a fitted state of the PSU connector and the power supply cable according to the first modification;

FIG. 20 is a front view of a power supply cable according to a second modification;

FIG. 21A is a front view of a PSU connector according to the second modification; and

FIG. 21B is a cross-sectional view of the PSU connector along line H-H′.

### DESCRIPTION OF EMBODIMENTS

Hereinafter, embodiments of an information processing apparatus, a power supply control device, and a power supply control method according to the present application are described in details with reference to the drawings. Note that, the following embodiments are not intended to limit the information processing apparatus, the power supply control device, and the power supply control method according to the present application.

### First Embodiment

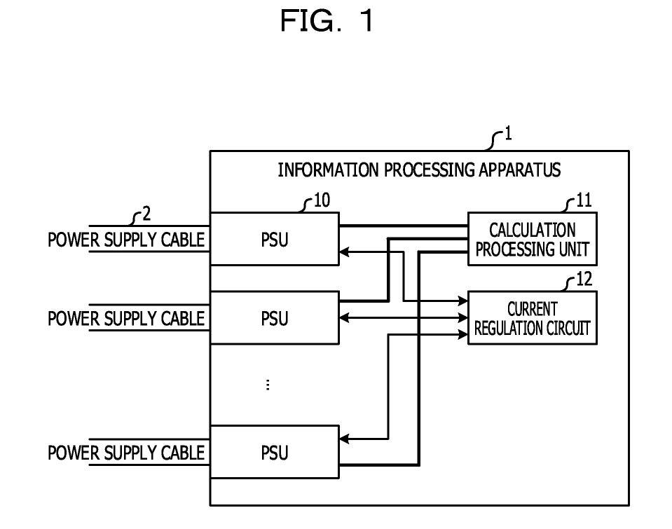

FIG. 1 is a block diagram of an information processing apparatus according to a first embodiment. As illustrated in FIG. 1, this information processing apparatus 1 according to this embodiment includes a PSU 10 that is an example of a power supply control device, a calculation processing unit 11, and a current regulation circuit 12. The calculation processing unit 11 includes a circuit that further steps down the voltage outputted from the PSU 10 in some cases.

The PSUs 10 in plurality are mounted on the information processing apparatus 1. The PSUs 10 are connected with power supply cables 2. The PSUs 10 receive electricity supply from the power supply cables 2. The PSUs 10 then perform processing such as voltage conversion of the supplied electricity, and supply the electricity after the processing to the calculation processing unit 11. The power supply cable 2 is, for example, an alternating current (AC) cable.

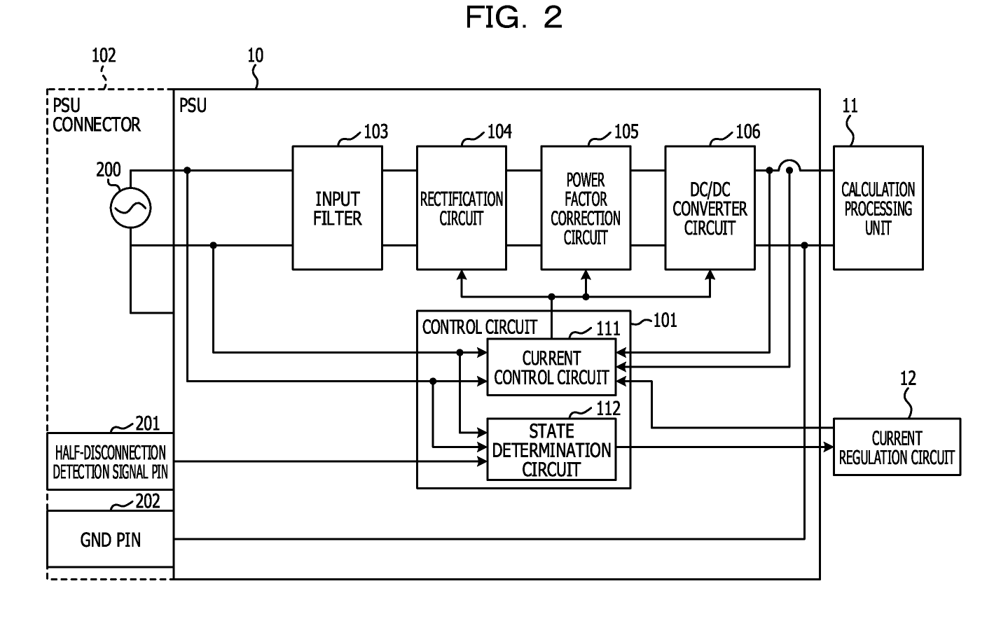

FIG. 2 is a block diagram illustrating a detail of a PSU according to the first embodiment. The PSU 10 includes, for example, a control circuit 101, a PSU connector 102, an input filter 103, a rectification circuit 104, a power factor correction circuit 105, and a direct current (DC)/DC converter circuit 106.

The PSU connector 102 is provided with a power source 200, a half-disconnection detection signal pin 201, and a ground (GND) pin 202.

The power source 200 receives electricity supply from the power supply cable 2. The power source 200 then outputs the supplied electric power to the input filter 103.

The GND pin 202 is a pin for a closed loop of the electricity outputted from the half-disconnection detection signal pin 201. The GND pin 202 is connected to a secondary side of a power transmission path connecting the calculation processing unit 11 and the DC/DC converter circuit 106.

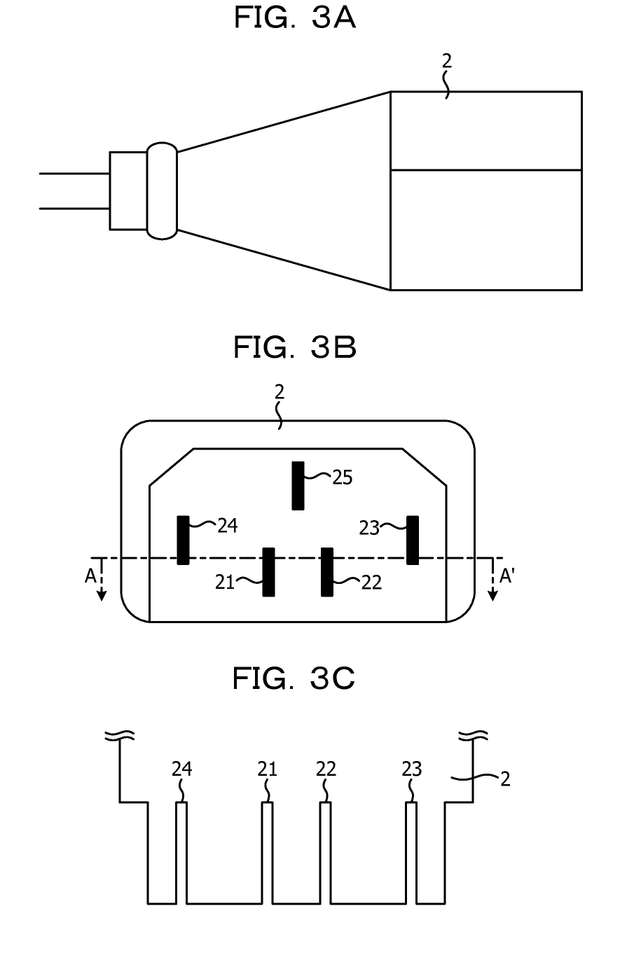

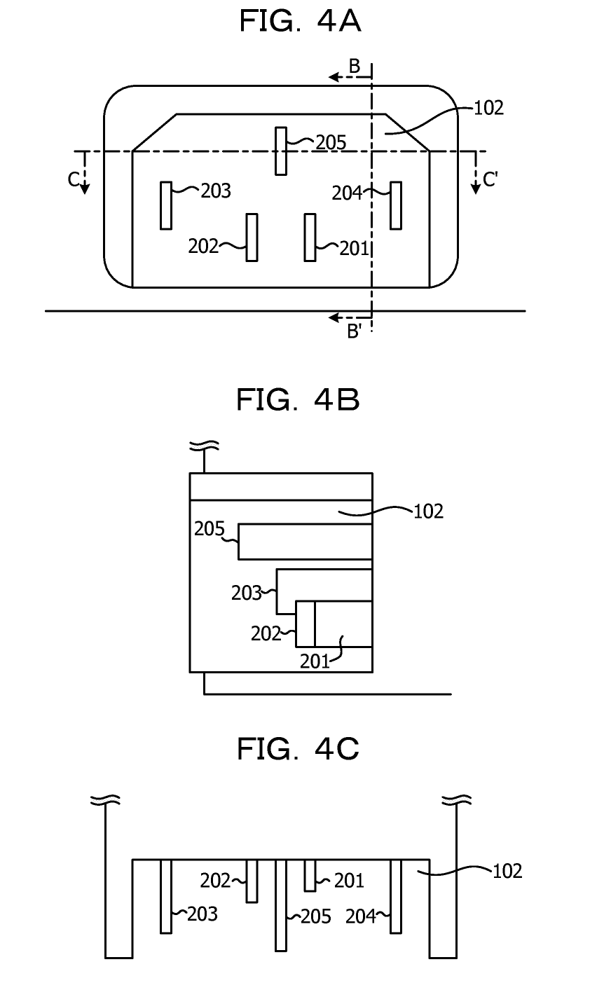

Here, with reference to FIGS. 3A to 3C and FIGS. 4A to 4C, the power supply cable 2 and the PSU connector 102 will be described. FIG. 3A is a side view of a power supply cable according to the first embodiment. FIG. 3B is a front view of the power supply cable according to the first embodiment. FIG. 3C is a cross-sectional view of the power supply cable along line A-A′.

The power supply cable 2 has a side in a right side in FIG. 3A that is connected to the PSU connector 102. FIG. 3B illustrates a front view of the power supply cable 2 viewed from the right side in FIG. 3A.

As illustrated in FIG. 3B, the power supply cable 2 includes, at the side that is connected to the PSU connector 102, a half-disconnection detection signal jack 21, a GND jack 22, an L jack 23, an N jack 24, and an FG jack 25.

The L jack 23 and the N jack 24 are disposed on both sides of a front surface of the power supply cable 2. Moreover, the FG jack 25 is disposed midway between the L jack 23 and the N jack 24. The L jack 23 and the N jack 24 serve as an example of a “first terminal”.

In addition, the half-disconnection detection signal jack 21 and the GND jack 22 are disposed on positions between the L jack 23 and the N jack 24 and facing the FG jack 25. The half-disconnection detection signal jack 21 serves as an example of a “second terminal”.

FIG. 3C illustrates an A-A′ cross section in FIG. 3B. As illustrated in FIG. 3C, in this embodiment, the L jack 23, the N jack 24, the half-disconnection detection signal jack 21, and the GND jack 22 all have the same depth. Moreover, although not being illustrated in FIG. 3C, the FG jack 25 also has the same depth as the other jacks. Note that, the depths of the jacks may not be the same as long as each of the jacks may have a depth to which each corresponding pin, which is described later, is fitted.

Next, with reference to FIGS. 4A to 4C, the PSU connector 102 will be described in details. FIG. 4A is a front view of a PSU connector according to the first embodiment. FIG. 4B is a cross-sectional view of the PSU connector along line B-B′. FIG. 4C is a cross-sectional view of the PSU connector along line C-C′.

As illustrated in FIG. 4A, the PSU connector 102 according to this embodiment includes the half-disconnection detection signal pin 201, the GND pin 202, an L pin 203, an N pin 204, and an FG pin 205.

The L pin 203 and the N pin 204 are disposed on both sides of the PSU connector 102. Moreover, the FG pin 205 is disposed between the L pin 203 and the N pin 204. The L pin 203, the N pin 204, and the FG pin 205 serve as the power source 200. Further, the L pin 203 and the N pin 204 serve as an example of a “power supply terminal”.

In addition, the half-disconnection detection signal pin 201 and the GND pin 202 are disposed on positions between the L pin 203 and the N pin 204 and facing the FG pin 205. The half-disconnection detection signal pin 201 serves as an example of a “determination terminal”.

Here, FIG. 4B illustrates a B-B′ cross section in FIG. 4A. Moreover, FIG. 4C illustrates a C-C′ cross section in FIG. 4A. As illustrated in FIGS. 4B and 4C, the FG pin 205 is the longest. The L pin 203 and the N pin 204 are the second longest next to the FG pin 205. In this embodiment, the L pin 203 and the N pin 204 have the same length. The FG pin 205 is longer than the L pin 203 and the N pin 204, so that a contact between the FG pin 205 and the FG jack 25 is maintained while the L pin 203 and the N pin 204 are respectively inserted into and brought into contact with the L jack 23 and the N jack 24. Hereinafter, a state where a pin is inserted into and brought into contact with a corresponding jack is called “short” in some cases. Moreover, a state where the pin is removed from and becomes out of contact with the corresponding jack therewith is called “open” in some cases.

The GND pin 202 is the next longest. Further, the half-disconnection detection signal pin 201 is the shortest. The GND pin 202 is longer than the half-disconnection detection signal pin 201, so that a contact of the GND pin 202 is maintained while the half-disconnection detection signal pin 201 is in contact.

The half-disconnection detection signal pin 201, the GND pin 202, the L pin 203, the N pin 204, and the FG pin 205 have lengths as described the above, so that when the power supply cable 2 is removed from the PSU connector 102, the pins are removed in the following order. When the power supply cable 2 is started to be removed, the half-disconnection detection signal pin 201 is firstly removed. Next, the GND pin 202 is removed. Next, the L pin 203 and the N pin 204 are removed. The FG pin 205 is lastly removed.

The explanation is continued referring back to FIG. 2. The input filter 103 removes noise of the electric power inputted from the power source 200. The input filter 103 then outputs the electric power from which the noise is removed to the rectification circuit 104.

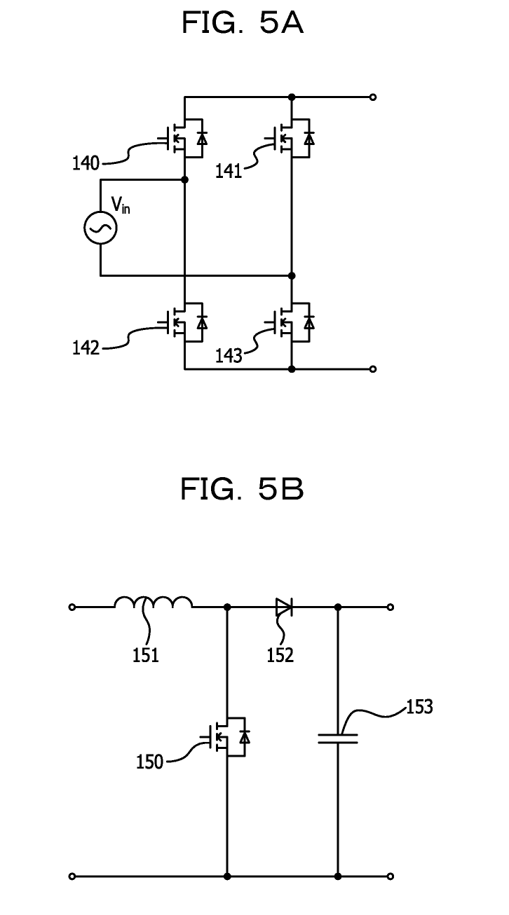

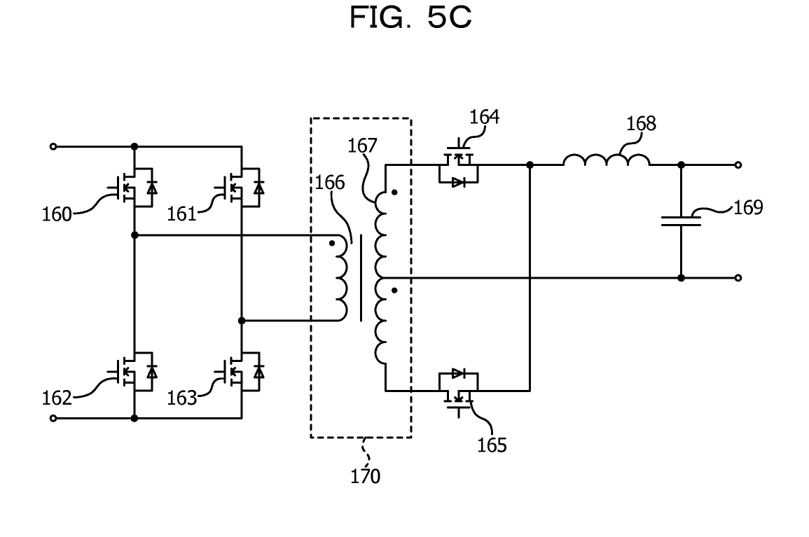

The rectification circuit 104 converts the electric power inputted from the input filter 103 from the alternating current to the direct current. The rectification circuit 104 then outputs the electric power converted into the direct current to the power factor correction circuit 105. For example, the rectification circuit 104 has a circuit configuration such as that illustrated in FIG. 5A. FIG. 5A is a circuit diagram of a rectification circuit. The rectification circuit 104 includes switches 140 to 143.

The power factor correction circuit 105 coverts the power factor of the electric power inputted from the rectification circuit 104. The power factor correction circuit 105 then outputs the electric power of which power factor is improved to the DC/DC converter circuit 106. For example, the power factor correction circuit 105 has a circuit configuration such as that illustrated in FIG. 5B. FIG. 5B is a circuit diagram of a power factor correction circuit. The power factor correction circuit 105 includes a switch 150, an inductor 151, a diode 152, and a capacitor 153.

The DC/DC converter circuit 106 is a DC-DC converter circuit that insulates a primary side from a secondary side. For example, the DC/DC converter circuit 106 has a circuit configuration such as that illustrated in FIG. 5C. FIG. 5C is a circuit diagram of a DC/DC converter circuit. The DC/DC converter circuit 106 includes switches 160 to 165, a primary-side coil 166, a secondary-side coil 167, an inductor 168, and a capacitor 169. The primary-side coil 166 and the secondary-side coil 167 constitute one insulating transformer 170. The DC/DC converter circuit 106 converts the voltage of the electric power inputted from the power factor correction circuit 105 into the operation voltage of the calculation processing unit 11. The DC/DC converter circuit 106 then outputs the electric power of which voltage is converted to the calculation processing unit 11.

Moreover, as described later, when the power supply cable 2 is in a half-disconnected state, the rectification circuit 104, the power factor correction circuit 105, and the DC/DC converter circuit 106 output the electric power to the calculation processing unit 11 by changing the output current in accordance with an instruction by a current control circuit 111. The rectification circuit 104, the power factor correction circuit 105, the DC/DC converter circuit 106, and the like serve as an example of an “electricity supply unit”.

The control circuit 101 includes the current control circuit 111 and a state determination circuit 112.

The state determination circuit 112 monitors the input voltage from the half-disconnection detection signal pin 201, and determines whether or not the power supply cable 2 is in a half-disconnected state. For example, if the half-disconnection detection signal pin 201 is in a short state, the state determination circuit 112 determines that the power supply cable 2 is not in a half-disconnected state, that is, is appropriately inserted. On the other hand, if the half-disconnection detection signal pin 201 is in an open state, the state determination circuit 112 determines that the power supply cable 2 is in a half-disconnected state. Here, in the case where the half-disconnection detection signal pin 201 is in an open state, there may be a state where the power supply cable 2 is removed. However, such a case is not considered as a determination condition in this embodiment because the state determination circuit 112 receives no electricity supply and thus is unable to perform determination processing.

If detecting that the power supply cable 2 is in a half-disconnected state, the state determination circuit 112 notifies the current regulation circuit 12 that the power supply cable 2 is in a half-disconnected state.

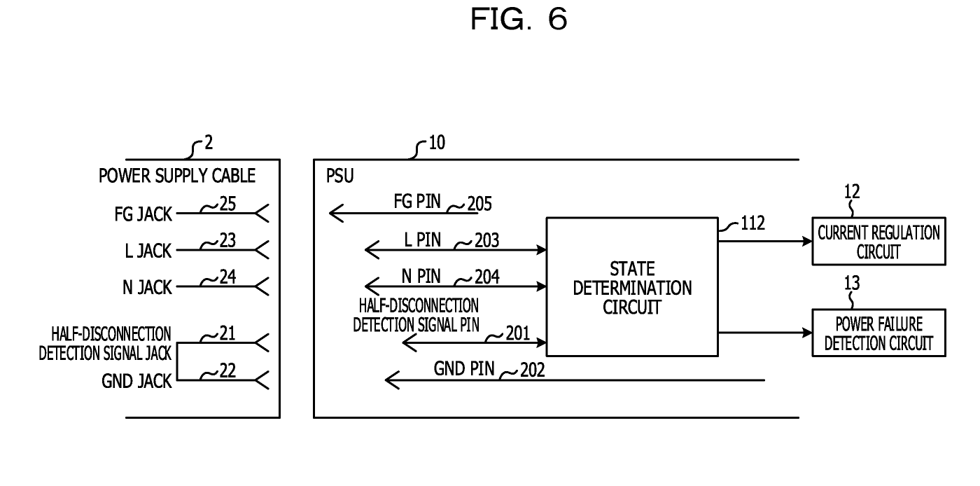

In addition, with reference to FIG. 6, detection of a half-disconnected state and a power failure of the power supply cable 2 by the PSU 10 will be described. FIG. 6 is a diagram for explaining a flow of signals due to a connection between the PSU and the power supply cable according to the first embodiment.

When the L jack 23 and the L pin 203 are in a short state and the electricity is supplied from the power supply cable 2, the state determination circuit 112 receives the input voltage from the L pin 203. Moreover, when the N jack 24 and the N pin 204 are in a short state and the electricity is supplied from the power supply cable 2, the state determination circuit 112 receives the input voltage from the N pin 204. The FG pin 205 inserted into the FG jack 25 is grounded.

When the state of the half-disconnection detection signal jack 21 and the half-disconnection detection signal pin 201 is transited from a short state to an open state, the state determination circuit 112 detects that the power supply cable 2 is in a half-disconnected state. The state determination circuit 112 then notifies the current regulation circuit 12 that the power supply cable 2 is in a half-disconnected state.

Upon receiving an input of voltage from the half-disconnection detection signal pin 201 after notifying the half-disconnected state of the power supply cable 2, the state determination circuit 112 then determines that the half-disconnection detection signal jack 21 and the half-disconnection detection signal pin 201 recover to the short state. The state determination circuit 112 then notifies the current regulation circuit 12 that the half-disconnected state of the power supply cable 2 is resolved. The state determination circuit 112 serves as an example of a “detection unit”.

When the state determination circuit 112 in any of the PSUs 10 detects the half-disconnected state of the power supply cable 2, the current control circuit 111 receives an instruction of current regulation from the current regulation circuit 12. Specifically, the current control circuit 111 in the PSU 10 in which a half-disconnected state of the power supply cable 2 is detected receives a signal to decrease the output current from the current regulation circuit 12. Moreover, the current control circuits 111 in the PSUs 10 other than the PSU 10 in which the half-disconnected state of the power supply cable 2 is detected receive signals to increase the output current from the current regulation circuit 12.

More specifically, the current control circuit 111 receives a current command signal from the current regulation circuit 12. The current control circuit 111 then detects, for example, the voltage level of the received current command signal, and outputs gate pulse signals to determine increase or decrease in output current to the rectification circuit 104, the power factor correction circuit 105, and the DC/DC converter circuit 106. Here, as illustrated in FIGS. 5A to 5C, each circuit determines the output voltage and the output current through a switching operation by an FET in this embodiment. This allows the current control circuit 111 to regulate the output current by regulating the pulse of the gate voltage that is inputted to the FET of each circuit.

The calculation processing unit 11 includes, for example, a CPU, a memory, a hard disk, and the like. The calculation processing unit 11 receives electricity supply from the PSUs 10. The calculation processing unit 11 then performs calculation using the supplied electricity. The calculation processing unit 11 includes a voltage converter circuit that further steps down the voltage of the electricity outputted from the PSU 10 in some cases.

The current regulation circuit 12 receives notification that the power supply cable 2 is in a half-disconnected state from the state determination circuit 112. Hereinafter, a PSU 10 from which a power supply cable 2 is in a half-disconnected state is called “semi-disengaged PSU 10”. The current regulation circuit 12 then obtains, for example, a value in which the output current before regulation of the semi-disengaged PSU 10 is reduced in half as the output current after regulation of the semi-disengaged PSU 10. Next, the current regulation circuit 12 calculates the increased amounts of current of the other PSUs 10 such that the current that is decreased in the semi-disengaged PSU 10 is divided by the number of the other PSUs 10. The normal PSUs 10 are each increased in current value by a value obtained such that a current value of the decreased amount is divided by the number of the remaining PSUs 10, that is, the shortage amount is equally allocated, however, this does not have to be equally allocated. Alternatively, the current value of the decreased amount may be added to a current value of one normal PSU 10. Note that, the current value of the one normal PSU 10 is increased within the current range that the PSU 10 may supply. The current regulation circuit 12 then obtains a value in which the output current before regulation of the PSU 10 other than the semi-disengaged PSU 10 is increased by the calculated increased amount as the output current after regulation of the PSU 10 other than the semi-disengaged PSU 10.

The current regulation circuit 12 then outputs a current command signal to each of the PSUs 10 so as to become the obtained output current after regulation.

Here, in this embodiment, although an explanation is made in a case where a power supply cable 2 for one PSU 10 is merely in a half-disconnected state and the output current of the semi-disengaged PSU 10 is reduced to half, the regulation rate of the output current is not limited to this. Actually, the regulation rate of the output current may preferably set in accordance with the stroke length of the half-disconnection detection signal pin 201 and the generation of heat by the power supply cable 2 and the PSU connector 102. The output current of the semi-disengaged PSU 10 may be preferably lowered, even if the power supply cable 2 is in a half-disconnected state, to such an extent that the power supply cable 2 and the PSU connector 102 generate no heat but an operation rate of the PSU 10 is dropped. Further, the extent that the operation rate of the PSU 10 is dropped is determined depending on a contact resistance of the pin obtained from the stroke length of the half-disconnection detection signal pin 201. Accordingly, the amount for dropping operation rate of the PSU 10 is determined based on the contact resistance of the half-disconnection detection signal pin 201.

Moreover, even in a case where semi-disengaged PSUs 10 are two or more, similar to the case where semi-disengaged PSU 10 is one, the current regulation circuit 12 reduces the output current of the semi-disengaged PSU 10 to such an extent that the power supply cable 2 and the PSU connector 102 generate no heat. The current regulation circuit 12 then causes the remaining PSUs 10 to share the current caused to be reduced.

In addition, the current regulation circuit 12 notifies a person in charge of the information processing apparatus 1 of the half-disconnected state. For example, the current regulation circuit 12 displays a message on a monitor or the like to make it possible to notify the person in charge of the half-disconnected state.

After regulating the output current, when the current regulation circuit 12 receives elimination of the half-disconnected state of the power supply cable 2 from the state determination circuit 112, the current regulation circuit 12 returns the output current of all the PSUs 10 to be equal. The current regulation circuit 12 serves as an example of a “current controller”.

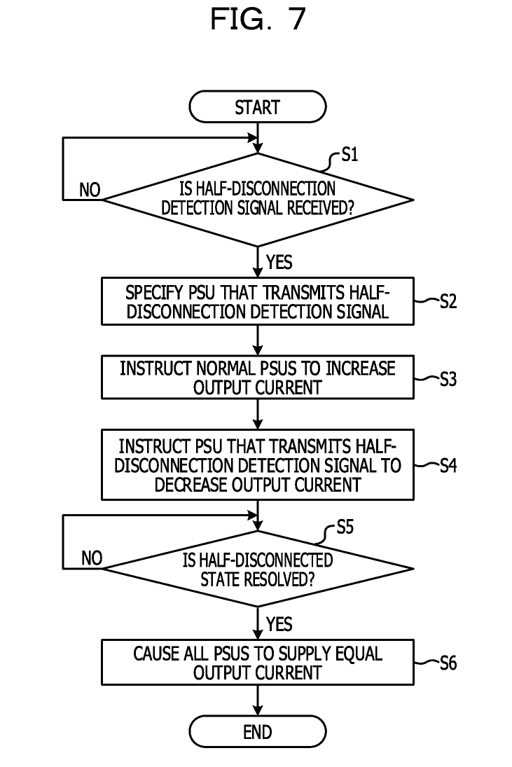

Next, with reference to FIG. 7, an overall flow of power supply control by the information processing apparatus 1 according to this embodiment will be described. FIG. 7 is a flowchart of power supply control by the information processing apparatus according to the first embodiment.

The current regulation circuit 12 determines whether or not a half-disconnection detection signal is received from the state determination circuit 112 (step S1). If the half-disconnection detection signal is not received (step S1: No), the current regulation circuit 12 waits until the half-disconnection detection signal is received.

In contrast, if the half-disconnection detection signal is received (step S1: Yes), the current regulation circuit 12 specifies a semi-disengaged PSU 10 as a PSU 10 that transmits the half-disconnection detection signal (step S2).

The current regulation circuit 12 then obtains the output current of each of the PSUs 10. The current regulation circuit 12 then instructs to increase the output current to normal PSUs 10, that is, PSUs 10 other than the semi-disengaged PSU 10 (step S3).

Moreover, the current regulation circuit 12 instructs to decrease the output current to the PSU 10 to which the half-disconnection detection signal is transmitted, that is, the semi-disengaged PSU 10 (step S4).

Thereafter, the current regulation circuit 12 determines whether or not the half-disconnected state of the power supply cable 2 is resolved based on the notification from the state determination circuit 112 (step S5). If the half-disconnected state is not resolved (step S5: No), the current regulation circuit 12 waits until the half-disconnected state is resolved.

In contrast, if the half-disconnected state is resolved (step S5: Yes), the current regulation circuit 12 causes the output current of all the PSUs 10 to be equal (step S6).

As explained in the foregoing, the information processing apparatus according to this embodiment detects a half-disconnected state of the power supply cable, decreases the output current of a PSU in the half-disconnected state, and increases the output current of other PSUs. This makes it possible to restrict generation of heat in the pin and the jack that occurs when the power supply cable is in a half-disconnected state, and reduce deterioration in the power supply cable and the PSU connector. Moreover, maintaining the current amount of the entire PSUs makes it possible to perform stably electricity supply.

Moreover, when a power supply cable is in a half-disconnected state, the half-disconnected state is notified of a person in charge. This makes it possible to prompt the person in charge to reinsert the power supply cable. This makes it possible to rapidly dissolve the half-disconnected state of the power supply cable.

Moreover, in the explanation in the foregoing, although the current regulation circuit 12 is provided separated from the PSUs 10, the current regulation circuit 12 may be incorporated into each of the PSUs. In that case, such a configuration may be applied in which any one of current control circuits that are mounted on the PSUs other than the semi-disengaged PSU is set as a master current control circuit, and the master current control circuit obtains shares of the output current for the PSUs and instructs the PSUs to increase or decrease the output current in accordance with the obtained shares.

### Second Embodiment

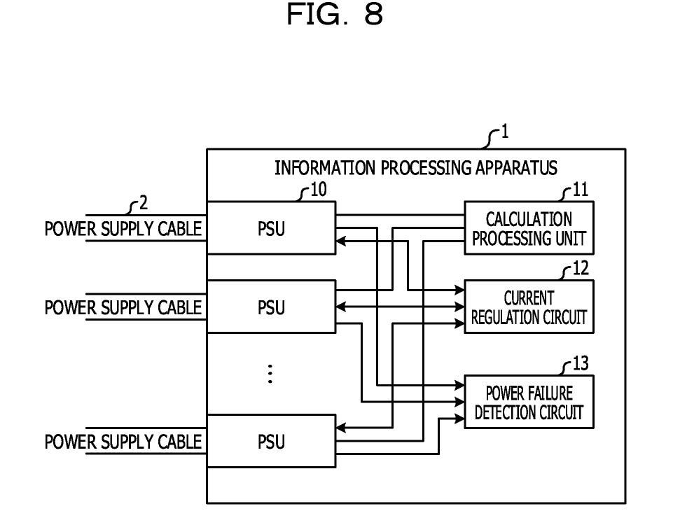

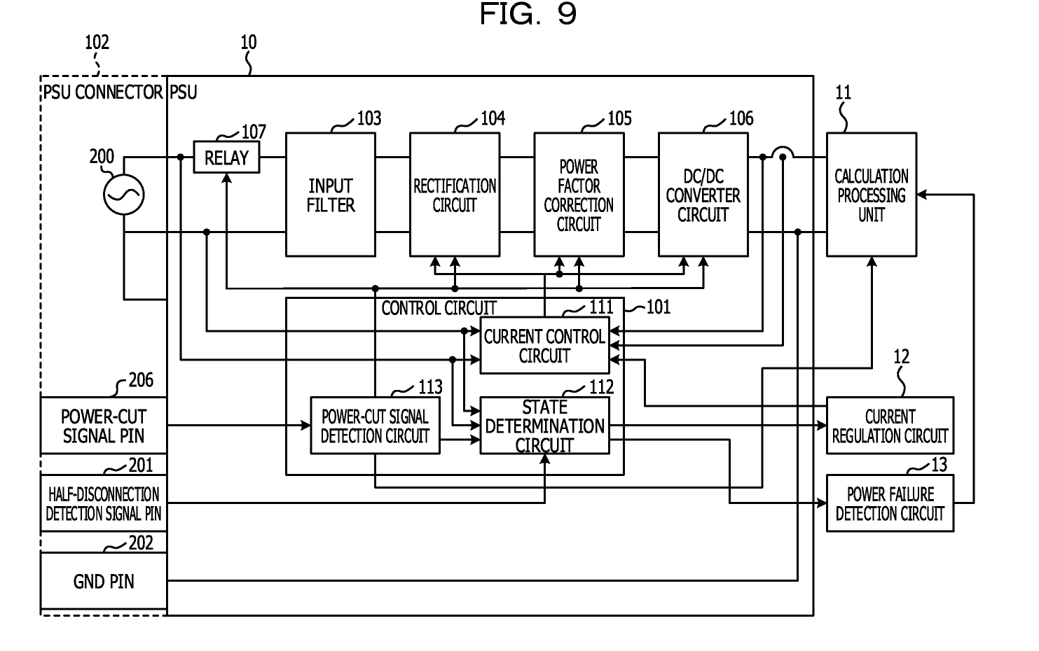

FIG. 8 is a block diagram of an information processing apparatus according to a second embodiment. As illustrated in FIG. 8, the information processing apparatus 1 according to this embodiment includes a power failure detection circuit 13 in addition to the units in the information processing apparatus 1 according to the first embodiment. In addition, FIG. 9 is a block diagram illustrating a detail of a PSU according to the second embodiment. As illustrated in FIG. 9, the PSU 10 according to this embodiment includes a relay 107, a power-cut signal pin 206, and a power-cut signal detection circuit 113, in addition to the units in the PSU 10 according to the first embodiment. In the following explanation, explanations are omitted with respect to the units having similar functions to the first embodiment.

Only one PSU 10 is mounted on the information processing apparatus, and when an AC power supply is in a loss state, the PSU 10 is unable to perform a control because no control power supply is present in the PSU, in other words, is unable to perform a state determination. However, the information processing apparatus normally has a redundant configuration as for the PSU 10, such as the configuration of receiving power in two systems or mounting a plurality of units, and thus when a failure or a system power failure occurs, an operation is able to be continued. Moreover, when the power supply for the PSU 10 is in a loss state, for example, when a power supply cable is removed, the PSU 10 is supplied with control power supply from another PSU 10, and is able to perform a control, in other words, is able to perform a state determination. Moreover, even when all the power supplies are lost, the PSU 10 includes a capacitor embedded therein to cope with an instantaneous power failure and the like. Accordingly, the PSU 10 is able to hold the output voltage in a period of several tens of milliseconds to several hundreds of milliseconds, and the PSU 10 is able to perform a control, in other words, is able to perform a state determination, in this period.

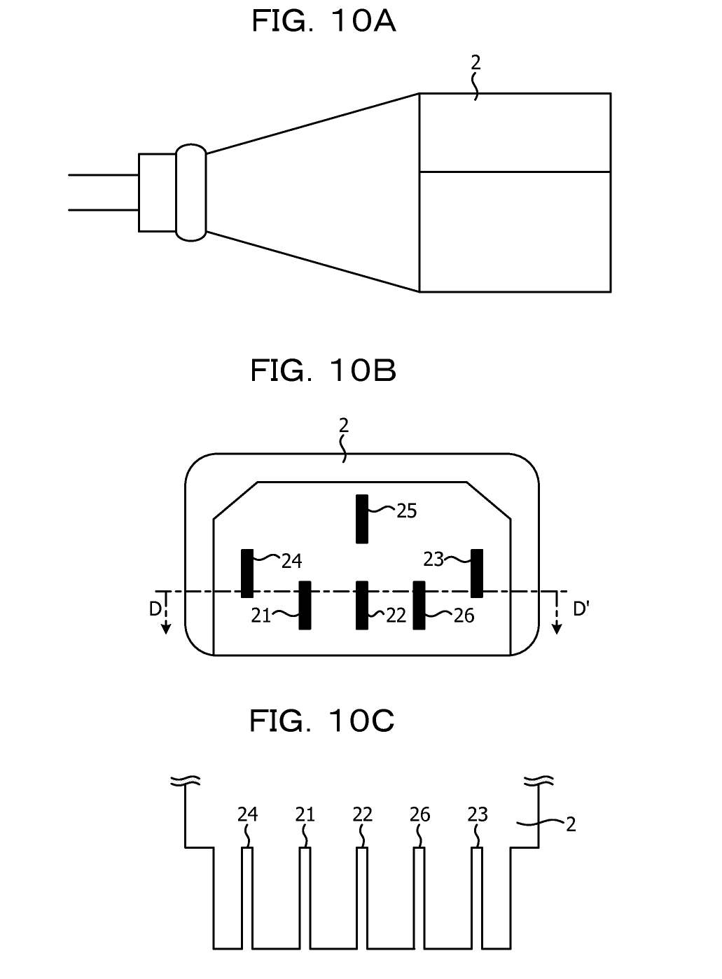

FIG. 10A is a side view of a power supply cable according to the second embodiment. Moreover, FIG. 10B is a front view of the power supply cable according to the second embodiment. Moreover, FIG. 10C is a cross-sectional view of the power supply cable along line D-D′.

As illustrated in FIG. 10B, the power supply cable 2 according to this embodiment includes a power-cut signal jack 26, in addition to the jacks in the first embodiment.

In this embodiment, the GND jack 22 is disposed on between the L jack 23 and the N jack 24 and facing the FG jack 25. Further, the power-cut signal jack 26 is disposed at the L jack 23 side and the half-disconnection detection signal jack 21 is disposed at the N jack 24 side so as to sandwich the GND jack 22 therebetween. The power-cut signal jack 26 serves as an example of a “third terminal”.

FIG. 10C illustrates a D-D′ cross section in FIG. 10B. As illustrated in FIG. 10C, in this embodiment, the L jack 23, the N jack 24, the half-disconnection detection signal jack 21, the GND jack 22, and the power-cut signal jack 26 all have the same depth. Note that, the depths of the jacks may not be the same as long as each of the jacks may have a depth into which each corresponding pin, which is described later, is fitted.

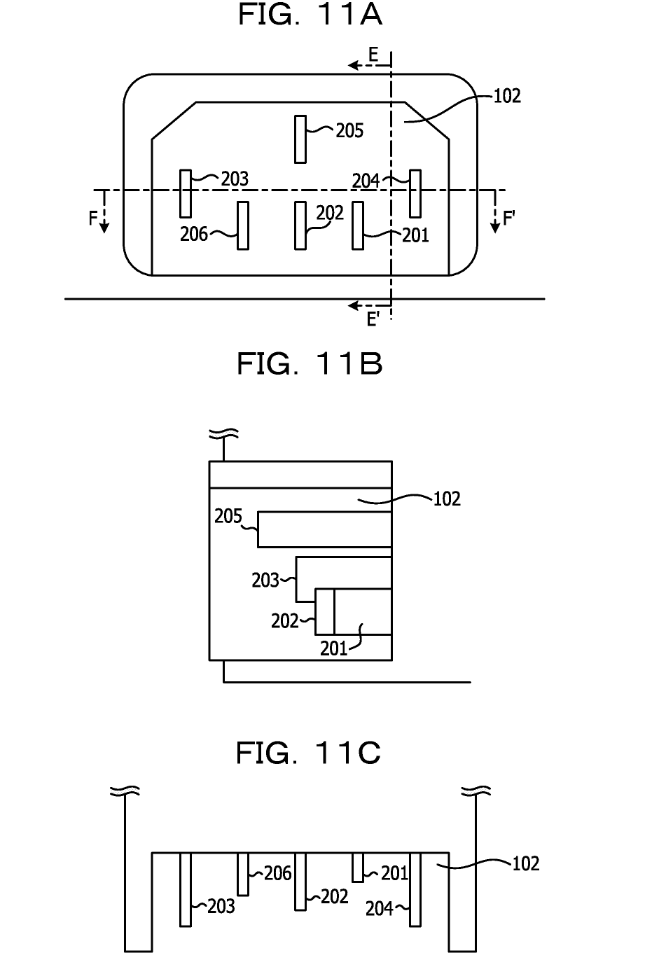

Next, with reference to FIGS. 11A to 11C, the PSU connector 102 will be described in details. FIG. 11A is a front view of a PSU connector according to the second embodiment. FIG. 11B is a cross-sectional view of the PSU connector along line E-E′. FIG. 11C is a cross-sectional view of the PSU connector along line F-F′.

As illustrated in FIG. 11A, the PSU connector 102 according to this embodiment includes the power-cut signal pin 206, in addition to the pins in the first embodiment.

The GND pin 202 is disposed on a position between the L pin 203 and the N pin 204 and facing the FG pin 205. Further, the power-cut signal pin 206 is disposed at the L pin 203 side and the half-disconnection detection signal pin 201 is disposed at the N pin 204 side so as to sandwich the GND pin 202 therebetween. The power-cut signal pin 206 serves as an example of a “power-cut determination terminal”.

Here, FIG. 11B illustrates an E-E′ cross section in FIG. 11A. Moreover, FIG. 11C illustrates an F-F′ cross section in FIG. 11A. As illustrated in FIGS. 11B and 11C, the FG pin 205 is the longest. The L pin 203 and the N pin 204 are the second longest next to the FG pin 205. In this embodiment, the L pin 203 and the N pin 204 have the same length. The FG pin 205 is longer than the L pin 203 and the N pin 204, so that a contact between the FG pin 205 and the FG jack 25 is maintained while the L pin 203 and the N pin 204 are respectively inserted into and brought into contact with the L jack 23 and the N jack 24.

The GND pin 202 is the next longest. Further, the power-cut signal pin 206 is the next longest. In addition, the half-disconnection detection signal pin 201 is the shortest. The GND pin 202 is longer than the half-disconnection detection signal pin 201 and the power-cut signal pin 206, so that the GND pin 202 is in a short state while the half-disconnection detection signal pin 201 or the power-cut signal pin 206 is in a short state. Moreover, the power-cut signal pin 206 is longer than the half-disconnection detection signal pin 201, so that the power-cut signal pin 206 is in a short state while the half-disconnection detection signal pin 201 is in a short state.

For example, the length of each pin is possible to be set as 12 mm for the L pin 203 and the N pin 204, 8 mm for the power-cut signal pin 206, and 4 mm for the half-disconnection detection signal pin 201.

The half-disconnection detection signal pin 201, the GND pin 202, the L pin 203, the N pin 204, the FG pin 205, and the power-cut signal pin 206 have lengths as described the above, so that when the power supply cable 2 is removed from the PSU connector 102, the pins are removed in the following order. When the power supply cable 2 is started to be removed, the half-disconnection detection signal pin 201 is firstly removed. Next, the power-cut signal pin 206 is removed. Next, the GND pin 202 is removed. Next, the L pin 203 and the N pin 204 are removed. The FG pin 205 is lastly removed.

When removal of the power supply cable 2 from the PSU connector 102 is started, and the short state of the power-cut signal pin 206 and the power-cut signal jack 26 is resolved, the power-cut signal detection circuit 113 receives a stop instruction signal from the power-cut signal pin 206 being in an open state. The power-cut signal detection circuit 113 instructs the rectification circuit 104, the power factor correction circuit 105, the DC/DC converter circuit 106, or the relay 107 to stop the electricity supply, and causes the PSU 10 to stop. Here, causing the PSU 10 to stop indicates that the current supplied from an input power supply for the PSU 10 to the PSU 10 is made to be approximate zero. The power-cut signal detection circuit 113 preferably makes the input current be approximate zero before the L pin 203 and the N pin 204 are removed. For example, the power-cut signal detection circuit 113 causes the PSU 10 to stop within 200 microseconds after receiving the stop instruction signal from the power-cut signal pin 206.

As a specific method of stopping the PSU 10, for example, the power-cut signal detection circuit 113 turns an electricity supply circuit into an open circuit by opening the relay 107 that is an analog circuit to disconnect the electricity supply circuit. Here, an analog circuit other than the relay 107 may be used as a circuit that turns the electricity supply circuit into an open circuit as long as the analog circuit can disconnect the electricity supply circuit.

Moreover, if it is possible to make the input current be approximate zero before the L pin 203 and the N pin 204 are removed, the power-cut signal detection circuit 113 may stop driving switching elements such as FETs provided in the rectification circuit 104, the power factor correction circuit 105, and the DC/DC converter circuit 106. For example, in a case of the rectification circuit 104 in FIG. 5A, the power-cut signal detection circuit 113 may stop driving the switches 140 to 143 to make the input current be approximate zero. Moreover, in a case of the power factor correction circuit 105 in FIG. 5B, the power-cut signal detection circuit 113 may stop driving the switch 150 to make the input current be approximate zero. Moreover, in a case of the DC/DC converter circuit 106 in FIG. 5C, the power-cut signal detection circuit 113 may stop driving the switches 160 to 165 to make the input current be approximate zero.

The circuit that stops the PSU in this manner upon receiving an instruction from the power-cut signal detection circuit 113 may be preferably configured by a hardware that allows a high-speed data response. This is because performing a stop instruction through software results in the long stop processing time due to the many occurrences of delay in calculation processing and the like, and thus the PSU might not be stopped before the L pin 203 and the N pin 204 are removed.

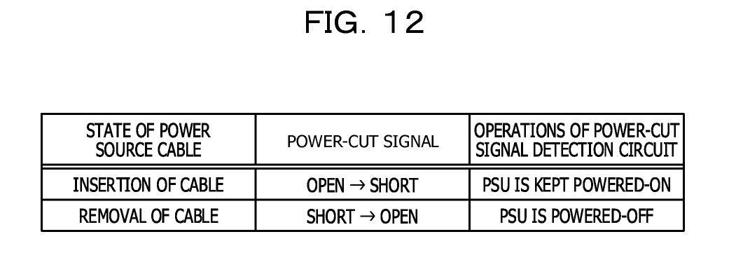

Here, with reference to FIG. 12, an operation the power-cut signal detection circuit 113 when a power supply cable is inserted or removed will be described collectively. FIG. 12 is a table for explaining an operation of a power-cut signal detection circuit when the power supply cable is inserted or removed. The item of power-cut signal in FIG. 12 represents transition of a power-cut signal detected by the power-cut signal detection circuit 113.

When the power supply cable 2 is inserted, a power-cut signal is transited from open to short. At this time, the power-cut signal detection circuit 113 allows the power supply of the PSU 10 to remain on.

In contrast, when the power supply cable 2 is removed, a power-cut signal is transited from short to open. At this time, the power-cut signal detection circuit 113 performs processing of turning off the power supply of the PSU 10.

In this manner, stopping the PSU 10 by the power-cut signal detection circuit 113 after the power-cut signal pin 206 is removed and before the L pin 203 and the N pin 204 are removed makes it possible to restrict arc from being generated. This allows an operator who performs maintenance of the information processing apparatus 1 to remove the power supply cable 2 in an energized state without performing a PSU stop instruction.

In addition, upon receiving a stop instruction signal from the power-cut signal pin 206, the power-cut signal detection circuit 113 notifies the state determination circuit 112 of the reception of the stop instruction signal. Moreover, the power-cut signal detection circuit 113 notifies the calculation processing unit 11 of the execution of stopping the PSU 10 before stopping the PSU 10.

The state determination circuit 112 may perform a control below. When the power supply cable 2 starts to be come off from the PSU connector 102, the state determination circuit 112 receives a half-disconnection detection signal from the half-disconnection detection signal pin 201. Thereafter, if the power-cut signal pin 206 becomes in an open state and the state determination circuit 112 receives a stop instruction signal from the power-cut signal detection circuit 113 within a predetermined time, the state determination circuit 112 performs a notification of the half-disconnected state of the power supply cable 2. In contrast, if the state determination circuit 112 receives no stop instruction signal within the predetermined time, the state determination circuit 112 notifies the current regulation circuit 12 of the half-disconnected state of the power supply cable 2.

Moreover, the state determination circuit 112 monitors the input voltage from the L pin 203 and the N pin 204, and detects a power failure. For example, if the L pin 203 and the N pin 204 are respectively inserted into the L jack 23 and the N jack 24 and receive electricity supply, the state determination circuit 112 determines that the electricity is supplied from the power supply cable 2.

On the other hand, if no input voltage from the L pin 203 and the N pin 204 is present, the state determination circuit 112 determines whether or not the power-cut signal pin 206 is in a short state or an open state. If the power-cut signal pin 206 is in a short state, the state determination circuit 112 determines as a power failure. If detecting the power failure, the state determination circuit 112 notifies the power failure detection circuit 13 of the occurrence of the power failure.

In contrast, if the power-cut signal pin 206 is in an open state, the state determination circuit 112 determines that the power supply cable 2 is removed.

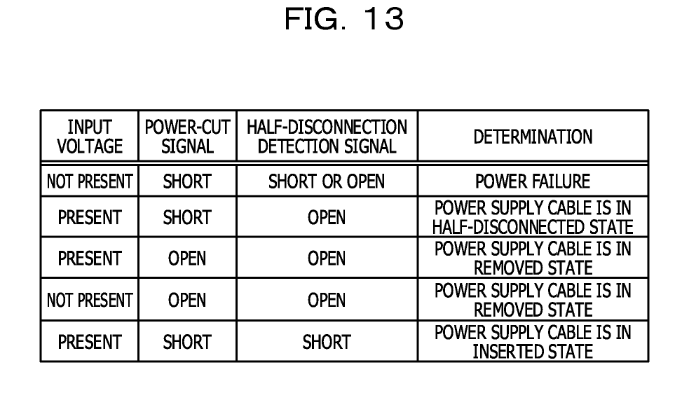

Here, with reference to FIG. 13, an operation of the state determination circuit 112 according to this embodiment will be described collectively. FIG. 13 is a table for explaining an operation of a state determination circuit. The item of input voltage represents the input voltage from the L pin 203 and the N pin 204 that is detected by the state determination circuit 112. The item of power-cut signal represents the power-cut signal the power-cut signal detection circuit 113. Moreover, the item of half-disconnection detection signal represents the half-disconnection detection signal detected by the state determination circuit 112.

If no input voltage is present and the power-cut signal is short, no input voltage is present even though the power supply cable 2 is inserted. In this case, the state determination circuit 112 determines as a power failure regardless of the state of the half-disconnection detection signal. Note that, if the power-cut signal is short, the half-disconnection detection signal is short normally.

If the input voltage is present, the power-cut signal is short, and the half-disconnection detection signal is open, it is considered that the power-cut signal pin 206 is entered, whereas the half-disconnection detection signal pin 201 is come off. In this case, the state determination circuit 112 determines that the power supply cable 2 is in a half-disconnected state.

If the input voltage is present, the power-cut signal is open, and the half-disconnection detection signal is open, it is considered that the L pin 203 and the N pin 204 are inserted, whereas the power-cut signal pin 206 and the half-disconnection detection signal pin 201 are removed. This is considered to be a case where the power supply cable 2 comes off from the PSU connector 102. In this case, the state determination circuit 112 determines that the power supply cable 2 is in a removed state.

If no input voltage is present, the power-cut signal is open, and the half-disconnection detection signal is open, it is considered that the L pin 203 and the N pin 204 are also come off. In this case, the state determination circuit 112 determines that the power supply cable 2 is in a removed state.

If the input voltage is present, the power-cut signal is short, and the half-disconnection detection signal is short, it is considered that all the pins are entered. In this case, the state determination circuit 112 determines that the power supply cable 2 is in an inserted state.

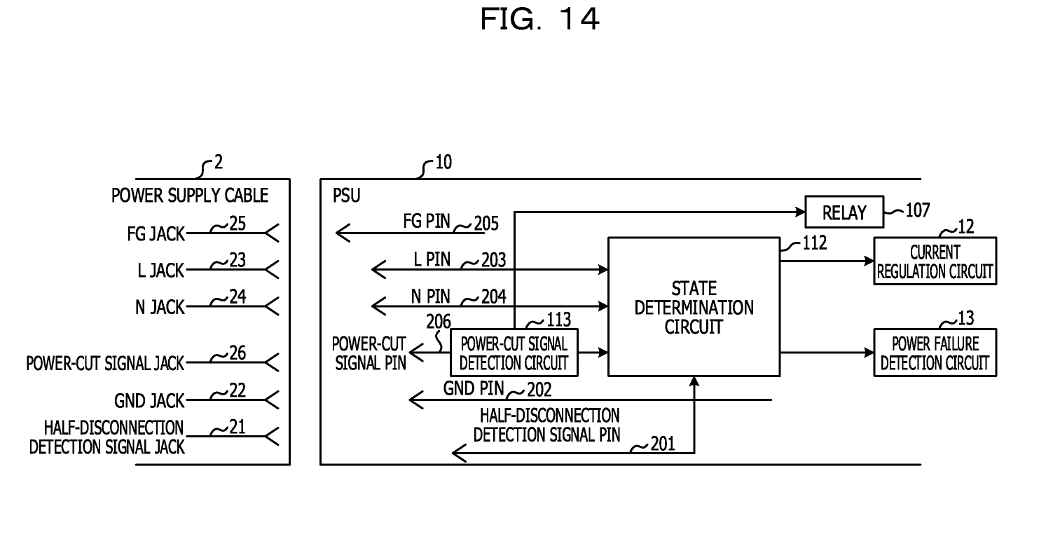

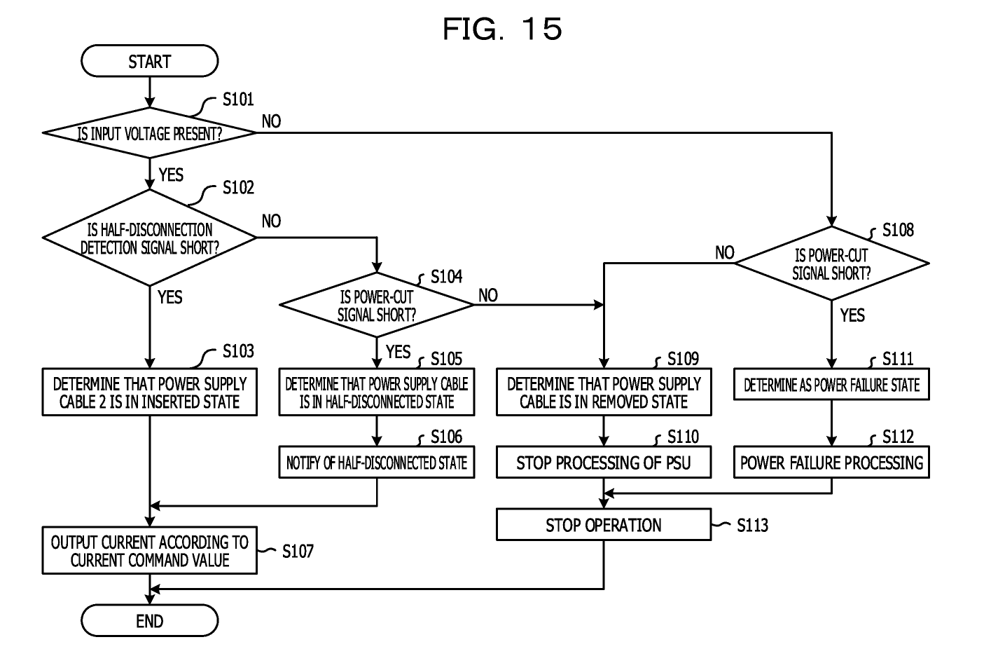

In addition, with reference to FIG. 14, detection by the PSU 10 of the half-disconnected state of the power supply cable 2 and a power failure will be described. FIG. 14 is a diagram for explaining a flow of signals due to a connection between the PSU and the power supply cable according to the second embodiment.

If the L jack 23 and the L pin 203 are in a short state and the electricity is supplied from the power supply cable 2, the state determination circuit 112 detects the input voltage from the L pin 203. Moreover, if the N jack 24 and the N pin 204 are in a short state and the electricity is supplied from the power supply cable 2, the state determination circuit 112 detects the input voltage from the N pin 204.

A power-cut signal outputted from the power-cut signal pin 206 in accordance with a connection state between the power-cut signal pin 206 and the power-cut signal jack 26 is then inputted into the power-cut signal detection circuit 113. The power-cut signal detection circuit 113 determines whether or not the PSU 10 is caused to stop using the received power-cut signal, and notifies the relay 107 if the PSU 10 is caused to stop. Herein, an explanation is made, as an example, a case where the PSU 10 is caused to stop using the relay 107.

Moreover, the state determination circuit 112 receives the power-cut signal from the power-cut signal detection circuit 113.

In addition, a half-disconnection detection signal outputted from the half-disconnection detection signal pin 201 in accordance with a connection state between the half-disconnection detection signal pin 201 and the half-disconnection detection signal jack 21 is inputted into the state determination circuit 112.

The state determination circuit 112 then determines occurrence or nonoccurrence of a power failure and a state of the power supply cable 2, based on the input voltage, the power-cut signal, and the half-disconnection detection signal. If a power failure occurs, the state determination circuit 112 notifies the power failure detection circuit 13 of the occurrence of the power failure. Moreover, if no power failure occurs, the state determination circuit 112 notifies the current regulation circuit 12 of a half-disconnection of the power supply cable 2 in accordance with a determination result.

Upon receiving the notification of the occurrence of the power failure from the state determination circuit 112, the power failure detection circuit 13 notifies the calculation processing unit 11.

Upon receiving the notification of the execution of stopping the PSU 10 from the power-cut signal detection circuit 113, the calculation processing unit 11 executes processing at an emergency stop such as processing of shifting data on a memory or recording a power failure event, as PSU stop processing.

Next, with reference to FIG. 15, a flow of power supply state determination by the information processing apparatus according to this embodiment will be described. FIG. 15 is a flowchart of power supply state determination by the information processing apparatus according to the second embodiment.

The state determination circuit 112 determines whether or not the input voltage from the L pin 203 and the N pin 204 is present (step S101). If the input voltage is present (step S101: Yes), the state determination circuit 112 determines whether or not a half-disconnection detection signal is short (step S102).

If the half-disconnection detection signal is short (step S102: Yes), the state determination circuit 112 determines that the power supply cable 2 is in an inserted state (step S103). The state determination circuit 112 then advances the process to step S107.

In contrast, if the half-disconnection detection signal is not short, in other words, is open (step S102: No), the state determination circuit 112 determines whether or not a power-cut signal is short (step S104). If the power-cut signal is short (step S104: Yes), the state determination circuit 112 determines that the power supply cable 2 is in a half-disconnected state (step S105).

The state determination circuit 112 then notifies the current regulation circuit 12 that the power supply cable 2 is in a half-disconnected state (step S106).

The current control circuit 111 notifies the rectification circuit 104, the power factor correction circuit 105, and the DC/DC converter circuit 106 of output of current in accordance with a current command value received from the current regulation circuit 12. The rectification circuit 104, the power factor correction circuit 105, and the DC/DC converter circuit 106 output the current in accordance with the current command value to the calculation processing unit 11 (step S107).

In contrast, if the power-cut signal is not short, in other words, is open (step S104: No), the state determination circuit 112 advances the process to step S109.

On the other hand, if no input voltage is present (step S101: No), the state determination circuit 112 determines whether or not a power-cut signal is short (step S108). If the power-cut signal is not short, in other words, is open (step S108: No) or if the determination at step S104 is negative, the state determination circuit 112 determines that the power supply cable 2 is in a removed state (step S109).

The calculation processing unit 11 then receives the notification of the execution of stopping the PSU 10 from the power-cut signal detection circuit 113, and executes stop processing of the PSU 10 (step S110).

In contrast, if the power-cut signal is short (step S108: Yes), the state determination circuit 112 determines as a power failure state (step S111). In this case, the calculation processing unit 11 performs power failure processing such as acquisition of a power failure event and data retraction (step S112).

Thereafter, the information processing apparatus 1 stops the operation (step S113).

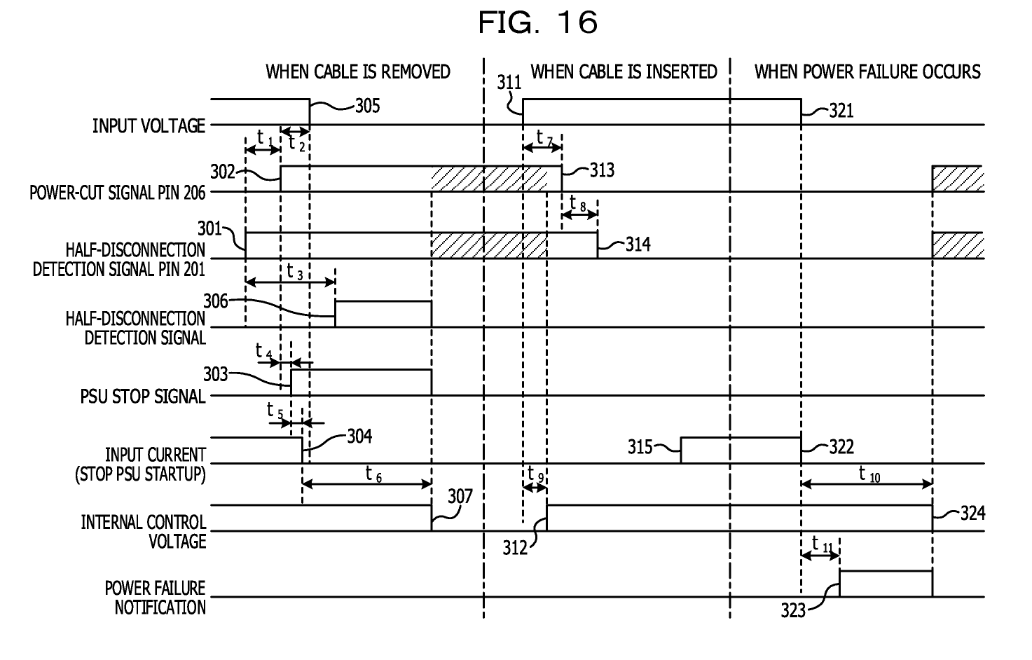

In addition, with reference to FIG. 16, an operation of the PSU 10 when the power supply cable 2 is removed and inserted, and a power failure occurs will be described. FIG. 16 is a timing chart of an operation of the PSU when the power supply cable is removed and inserted, and a power failure occurs. A time passes toward the right in FIG. 16.

When the power supply cable 2 is removed, the half-disconnection detection signal pin 201 is removed. Thereafter, the power-cut signal pin 206 is removed at timing 302. Here, t₁ is a period of time after the half-disconnection detection signal pin 201 is removed and before the power-cut signal pin 206 is removed.

Next, the power-cut signal detection circuit 113 outputs a stop signal of the PSU 10 to the relay 107, the rectification circuit 104, the power factor correction circuit 105, or the DC/DC converter circuit 106 at timing 303. Here, t₄ is a period of time after the power-cut signal pin 206 is removed and before the power-cut signal detection circuit 113 outputs the stop signal of the PSU 10.

Next, no input current to the PSU 10 is supplied, and the PSU 10 is stopped at timing 304. Here, t₅ is a period of time after the power-cut signal detection circuit 113 outputs the stop signal of the PSU 10 and before the PSU 10 is stopped.

Next, supply of the input voltage to the information processing apparatus 1 is stopped at timing 305. Here, t₂ is a period of time after the power-cut signal pin 206 is removed and before the L pin 203 and the N pin 204 are removed. In other words, the PSU 10 is preferably stopped during the time t₂.

Next, the state determination circuit 112 detects a half-disconnection detection signal at timing 306. Here, t₃ is a period of time after the half-disconnection detection signal pin 201 is removed and before the state determination circuit 112 detects the half-disconnection detection signal. The time t₃ is preferably longer than the time obtained by adding the time t₁ and the time t₂. This reduces notification of half-disconnection performed by the state determination circuit 112 because the state determination circuit 112 receives the power-cut signal in advance.

The control voltage of the PSU 10 is lost at timing 307. t₆ is a period of time after the input current to the PSU 10 is lost and before the control power supply of the PSU 10 is lost. After this, the state determination circuit 112 is unable to determine a state because no electricity is supplied to the PSU 10. Diagonally shaded areas in FIG. 16 indicate areas where the determination is impossible.

When the power supply cable 2 is inserted, supply of the input voltage to the information processing apparatus 1 is started at timing 311.

The control voltage of the PSU 10 is then recovered at timing 312. t₉ is a period of time after an input power supply is turned on and before the control power supply of the PSU 10 starts up. After this, the state determination circuit 112 operates, and is able to determine a state of the power supply cable 2.

Next, the power-cut signal pin 206 is in a short state at timing 313. t₇ is a period of time after the L pin 203 and the N pin 204 are inserted and before the power-cut signal pin 206 is in a short state.

Next, the half-disconnection detection signal pin 201 is in a short state at timing 314. t₈ is a period of time after the power-cut signal pin 206 is inserted and before the half-disconnection detection signal pin 201 is inserted.

Thereafter, supply of the input current to the PSU 10 is started at timing 315, and the PSU 10 starts up.

When a power failure occurs, a power failure occurs at timing 321, and the electricity supply to the information processing apparatus 1 is lost. Moreover, supply of the input current to the PSU 10 is also lost at timing 322 that is the same timing.

Thereafter, the power failure detection circuit 13 notifies the calculation processing unit 11 of the power failure at timing 323. t₁₁ is a period of time after the power supply of the information processing apparatus 1 is lost due to the power failure and before the power failure detection circuit 13 performs the notification of the power failure.

The control voltage of the PSU 10 is then lost at timing 324. t₁₀ is similar to t₆, and is a period of time after the input current to the PSU 10 is lost and before the control power supply of the PSU 10 is lost. Thereafter, the state determination circuit 112 is unable to determine a state.

As explained in the foregoing, the information processing apparatus according to this embodiment is able to isolate a cause of loss of the input power supply to the PSU. This makes it possible to rapidly cope with the trouble of the information processing apparatus.

Moreover, a power supply cable may be inserted or removed in the information processing apparatus in some cases, however, removing the power supply cable when the PSU is in an energized state generates arc. The generation of arc might cause damage in the power supply cable or the PSU connector due to heat of the arc. Accordingly, conventionally, a power supply cable is removed after a PSU is turned off to be in a non-energized state from the viewpoint of securing the reliability and the quality of a jack unit of the power supply cable and a pin unit of a PSU connector.

In contrast, with the information processing apparatus according to this embodiment, when a power supply cable is removed from a PSU connector in an energized state, a PSU is stopped. This makes it possible to reduce generation of arc, and reduce damage in the power supply cable and the PSU connector due to heat of the arc.

(First Modification)

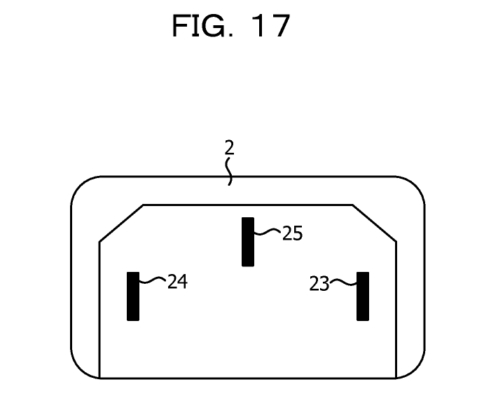

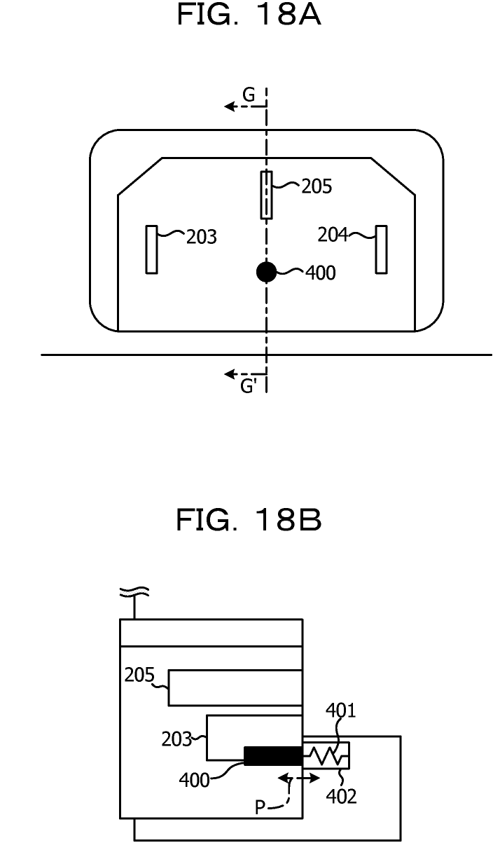

Next, a first modification in the second embodiment will be described. FIG. 17 is a front view of a power supply cable according to the first modification. Moreover, FIG. 18A is a front view of a PSU connector according to the first modification. Moreover, FIG. 18B is a cross-sectional view of the PSU connector along line G-G.

A PSU according to this modification is different from the second embodiment in that the PSU is provided with a movable unit, and determines a state of the power supply cable with a stroke of the movable unit.

As illustrated in FIG. 17, the L jack 23, the N jack 24, and the FG jack 25 are disposed on the power supply cable 2 according to this modification.

Further, the PSU connector 102 is provided with, as illustrated in FIG. 18A, a movable unit 400 in addition to the L pin 203, the N pin 204, and the FG pin 205. The movable unit 400 is provided so as to be brought into contact with a flat part on the front surface of the power supply cable 2.

In addition, the PSU connector 102 is provided with, as illustrated in FIG. 18B, a storage unit 402 that houses therein the movable unit 400. Further, an elastic member 401 such as a spring is provided between the movable unit 400 and a bottom surface of the storage unit 402. The movable unit 400 is movable in the direction indicated by an arrow P.

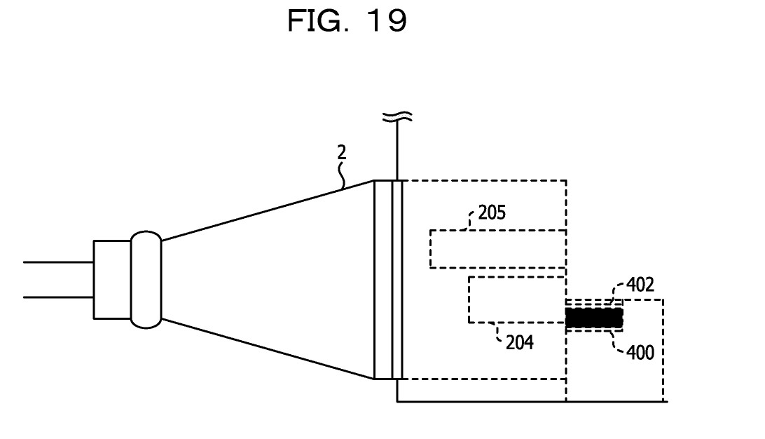

When the power supply cable 2 is inserted into the PSU connector 102, the movable unit 400 is brought into contact with the flat part on the front surface of the power supply cable 2, receives a pressing power toward the storage unit 402, and is gradually housed in the storage unit 402. When the power supply cable 2 is entirely inserted into the PSU connector 102, as in FIG. 19, the movable unit 400 is pushed into the storage unit 402. FIG. 19 is a view for explaining a fitted state of the PSU connector and the power supply cable according to the first modification.

The state determination circuit 112 acquires a relative position of the movable unit 400 with respect to the storage unit 402. Moreover, the state determination circuit 112 stores therein a threshold value 1 of the relative position for determining a half-disconnected state, and a threshold value 2 of the relative position for determining a removed state and indicating a position shallower than the position of the threshold value 1.

The state determination circuit 112 then determines as an inserted state if the movable unit 400 is positioned at a position the same as or deeper than the position of the threshold value 1. Moreover, the state determination circuit 112 determines as a half-disconnected state if the movable unit 400 is positioned at a position shallower than the position of the threshold value 1 and the same as or deeper than the position of the threshold value 2. In addition, the state determination circuit 112 determines as a removed state if the movable unit 400 is positioned at a position shallower than the position of the threshold value 2.

The state determination circuit 112 determines, using a state of the input voltage and a state of the power supply cable 2 obtained by the position of the movable unit 400, occurrence or nonoccurrence of a power failure and a state of power supply cable.

The power-cut signal detection circuit 113 also acquires a relative position of the movable unit 400 with respect to the storage unit 402. In addition, the power-cut signal detection circuit 113 also stores therein the threshold value 2. The power-cut signal detection circuit 113 then determines whether or not the power supply cable 2 is removed using a relation between the acquired position of the movable unit 400 and the threshold value 2.

Here, in this modification, although the power-cut signal detection circuit 113 acquires a position of the movable unit 400, and independently determines removal of the power supply cable 2, the invention is not limited to this. For example, the power-cut signal detection circuit 113 may acquire information on the removal of the power supply cable 2 from the state determination circuit 112.

Moreover, in this modification, although an explanation is made as a modification in the second embodiment, the configuration of determining half-disconnection of the power supply cable using the movable unit is also applicable to the first embodiment.

The information processing apparatus according to this modification makes it possible to implement the functions in the first embodiment and the second embodiment without changing the power supply cable. Moreover, this modification may be achieved by one pin, and thus is possible to reduce a use space on the PSU connector.

(Second Modification)

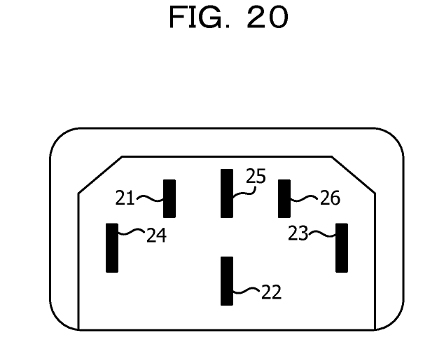

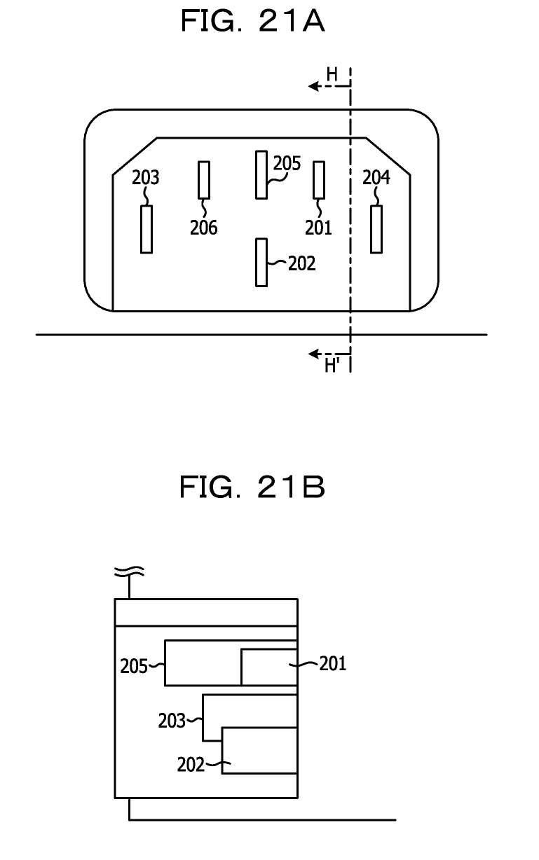

Next, a second modification in the second embodiment will be described. FIG. 20 is a front view of a power supply cable according to the second modification. Moreover, FIG. 21A is a front view of a PSU connector according to the second modification. Moreover, FIG. 21B is a cross-sectional view of the PSU connector along line H-H′.

The information processing apparatus according to this modification has a different arrangement of the pins in the PSU connector 102 from the case in the second embodiment illustrated in FIGS. 10A to 10C.

As illustrated in FIG. 20, the half-disconnection detection signal jack 21 and the power-cut signal jack 26 are disposed on the upper portion so as to sandwich the FG pin 205 therebetween in the power supply cable 2 according to this modification. The half-disconnection detection signal jack 21 is disposed at the L jack 23 side from the FG jack 25. Moreover, the power-cut signal jack 26 is disposed at the N jack 24 side from the FG jack 25.

As illustrated in FIGS. 21A and 21B, the half-disconnection detection signal pin 201 and the power-cut signal pin 206 are disposed on the upper portion so as to sandwich the FG pin 205 therebetween in the PSU connector 102 according to this embodiment. The half-disconnection detection signal pin 201 is disposed at the L pin 203 side from the FG pin 205. Moreover, the power-cut signal pin 206 is disposed at the N pin 204 side from the FG pin 205.

Here, there is a possibility that the power supply cable is obliquely inserted. In the arrangement of pins illustrated in FIG. 10B, short pins are concentrated in one position. For this reason, the pins might be inserted in a wrong order when the power supply cable is obliquely inserted. In contrast, disposing the pins as in this modification makes it possible to reduce a situation where the pins are inserted in a wrong order.

Moreover, also in the first embodiment, the half-disconnection detection signal pin may be disposed at the side of the FG pin.

In addition, in any of the embodiments and the modifications, the positions of the pins are not limited to the positions explained in the foregoing, but the pins may be disposed at appropriate positions.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a processor;
a plurality of power controllers, each of the power controllers includes:
an electricity supply that supplies electricity supplied from an inserted power supply cable to the processor, and
a detector that detects and notifies a half-disconnected state of the power supply cable; and
a current controller that in response to a notification from any of the detectors, decreases output current from the electricity supply in a power controller which falls under the half-disconnected state, and increases output current from an electricity supply in another power controller.

2. The information processing apparatus according to claim 1,
wherein the current controller decreases the output current from the electricity supply in the power controller which falls under the half-disconnected state by a predetermined value, and increases the output current from the electricity supply in the other power controllers such that the sum of increased amounts of the output current from the other power controllers is equal to the predetermined value.

3. The information processing apparatus according to claim 2,
wherein the current controller decreases the output current from the electricity supply in the power controller which falls under the half-disconnected state by the predetermined value, and increases the output current from the electricity supply in each of the other power controllers by a value calculated by dividing the predetermined value by the number of the other power controllers.

4. The information processing apparatus according to claim 1,
wherein the power controller further includes:
a power supply terminal that is fitted to a first terminal of the power supply cable, and receives the electricity supply; and
a determination terminal that is fitted to a second terminal of the power supply cable, and
the detector detects the half-disconnected state based on a fitted state of the determination terminal.

5. The information processing apparatus according to claim 4,
wherein the determination terminal is fitted to the second terminal of the power supply cable in a length in an insertion and removal direction shorter than a length in which the power supply terminal and the first terminal are fitted to each other, and
the detector detects the half-disconnected state when the determination terminal and the second terminal become out of contact with each other while the power supply terminal is in contact with the first terminal.

6. The information processing apparatus according to claim 1,
wherein the power controller further includes:
a power-cut determination terminal that is fitted to a third terminal of the power supply cable in a length in an insertion and removal direction shorter than a length in which the power supply terminal and the first terminal are fitted to each other and longer than a length in which the determination terminal and the second terminal are fitted to each other; and
an electricity supply interruption controller that interrupts the electricity supply when the power-cut determination terminal and the third terminal become out of contact with each other.

7. The information processing apparatus according to claim 6,
wherein the detector determines a cause for an input loss from the power supply cable, based on a contact state between the third terminal and the electricity supply interruption controller, and an electricity supply state in the power supply terminal.

8. A power controller comprising:
an electricity supply that supplies electricity supplied from a power supply cable inserted into the power controller to a processor;
a detector that detects a half-disconnected state of the power supply cable, and notifies another power controller of the detection of the half-disconnected state; and
a current controller that decreases output current from the electricity supply when the half-disconnected state is detected by the detector in the power controller, and increases output current from the electricity supply when a notification of the half-disconnected state is received from another power controller.

9. A power control method comprising:
detecting and notifying a half-disconnected state of a power supply cable inserted into a specific one of a plurality of power controllers that supply electricity to a processor;
decreasing output current from the specific power controller; and
increasing output current from any of the power controllers.
